(19) United States
(12) Patent Application Publication
(10) Pub. No.: US 2009/0129127 A1
(43) Pub. Date: May 21, 2009

(54) METHODS AND DEVICES FOR INHIBITING NEGATIVE OUTPUT CURRENT DURING START-UP OF A SWITCH MODE POWER SUPPLY

(76) Inventor: Lei Shi, Shenzhen (CN)

Correspondence Address: HARNESS, DICKEY, & PIERCE, P.L.C, 7700 Bonhomme, Suite 400, ST. LOUIS, MO, 63105, US

(21) Appl. No.: 11/942,673

(22) Filed: Nov. 19, 2007

(51) Int. Cl. H02M 1/00

(52) U.S. Cl. 363/49

(57) ABSTRACT

A method of controlling a freewheel switch during start-up of a switch mode power supply to inhibit negative output current. The switch mode power supply has alternating first and second intervals. The freewheel switch has an ON-time and an OFF-time. The method includes gradually increasing the ON-time of the freewheel switch over a plurality of said intervals during start-up of the switch mode power supply until the ON-time of the freewheel switch is substantially equal to a duration of the second interval.

### FIELD

The present disclosure relates to inhibiting negative output current during start-up of switch mode power supplies.

### BACKGROUND

The statements in this section merely provide background information related to the present disclosure and may not constitute prior art.

Switch mode power supplies frequently employ a transformer and one or more self-driven switches. The self-driven switches are controlled via the transformer to rectify output voltage to an output of the switch mode power supply. One example of such a switch mode power supply is illustrated in FIG. 1. The switch mode power supply 100 includes switches Q3-Q5. Switch Q3 is a freewheel switch. The freewheel switch Q3 is controlled by a switch Q6 and a control circuit 102. The switch mode power supply 100 operates cyclically as defined by Drives A and B, which are mutually exclusive (i.e., only one is asserted at any given time). During synchronous rectification mode, the output inductor is charged when Drive A is asserted and discharged when Drive B is asserted. The discharge interval is also referred to as the freewheeling interval, during which time the freewheel switch is closed.

During start-up of the switch mode power supply 100 (i.e., before synchronous rectification mode), a voltage is rapidly present at VCC of the control circuit 102. As Drives A and B are alternately asserted, the control circuit 102 defines a start-up delay to maintain the freewheel switch OFF during start-up. This start-up delay ensures transient perturbations settle before allowing the freewheel switch to be turned ON. The duration of the start-up delay is defined by a resistor R5, a capacitor C5, and a switch Q8 included in the control circuit 102. When capacitor C5 is sufficiently charged, switch Q8 turns ON, effectively turning a switch Q7 OFF. When switch Q7 is OFF, a drive switch Q6 is turned ON to end the start-up delay. Thereafter, the power supply operates in the synchronous rectification mode. During this mode, the freewheel switch Q3 is controlled by a drive signal provided by transformer winding L4 through the switch Q6 to a control terminal of the freewheel switch Q3. As illustrated in FIG. 2, the freewheel switch Q3 is turned ON when Drive B is asserted and turned OFF when Drive A is asserted.

When the freewheel switch Q3 is first turned ON during synchronous rectification mode, a change in the output voltage is detected by a pulse width modulation (PWM) control which provides Drives A and B. In response, the PWM control will adjust the duty cycles of Drives A and B. At this time, however, the output inductor L1 and the output capacitor C3 are not sufficiently charged to support the output voltage established before the freewheel switch Q3 was first turned ON. Therefore, a negative output current flows into the switch mode power supply 100. The negative output current causes the power supply output voltage to drop. This is illustrated in the waveform of FIG. 3, with the voltage drop indicated by reference numeral 302.

### SUMMARY

According to one aspect of the present disclosure, a method is provided for controlling a freewheel switch during start-up of a switch mode power supply to inhibit negative output current. The switch mode power supply has alternating first and second intervals, and the freewheel switch has an ON-time and an OFF-time. The method includes gradually increasing the ON-time of the freewheel switch over a plurality of the second intervals during start-up of the switch mode power supply until the ON-time of the freewheel switch is substantially equal to a duration of the second interval.

According to another aspect of this disclosure, a switch mode power supply having alternating first and second intervals includes a main switch, a freewheel switch, and a control circuit for defining an ON-time of the freewheel switch. The power supply is configured to close the main switch during each first interval. The control circuit is configured to gradually increase the ON-time of the freewheel switch over a plurality of the second intervals during start-up of the switch mode power supply until the ON-time of the freewheel switch is substantially equal to a duration of the second interval to thereby inhibit negative output current in the switch mode power supply.

According to yet another aspect of the present disclosure, a control circuit is provided for controlling a switch mode power supply having a drive switch, a freewheel switch, a main switch, and alternating first and second intervals. The main switch is configured to close during each first interval. The control circuit includes a first capacitor for providing a drive signal to the freewheel switch via the drive switch, the drive signal defining the ON-time of the freewheel switch, and a resistor coupled to the first capacitor. The first capacitor is configured to charge during the second interval. The resistor and the first capacitor are configured to gradually increase the drive signal over a plurality of the second intervals during start-up of the switch mode power supply until the ON-time of the freewheel switch is substantially equal to a duration of the second interval.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram of a switch mode power supply according to the prior art.

FIG. 2 is a timing diagram illustrating an ON-time of a freewheel switch in the switch mode power supply of FIG. 1.

FIG. 3 is a waveform diagram illustrating a drop in output voltage during start-up of the switch mode power supply of FIG. 1.

FIG. 4 is a waveform diagram illustrating a start-up control of a freewheel switch of a switch mode power supply according to the present disclosure.

FIG. 5 is a schematic view of a switch mode power supply according to the present disclosure.

FIG. 6 is a waveform diagram illustrating a drive signal to the freewheel switch of the switch mode power supply of FIG. 5.

FIG. 7 is a schematic view of a switch mode power supply including a control circuit.

FIG. 8 is a waveform diagram illustrating voltages at point C and point D of the switch mode power supply of FIG. 7 during start-up.

FIG. 9 is a waveform diagram illustrating a voltage at point C of the switch mode power supply of FIG. 7 during start-up.

FIG. 10 is a simulated waveform diagram illustrating the circled portion of the waveform of FIG. 9.

FIG. 11 is a waveform diagram illustrating a voltage at point D and output voltage of the switch mode power supply of FIG. 7 during start-up.

FIG. 12 is a waveform diagram illustrating output current and output voltage from the switch mode power supply of FIG. 7 during start-up while coupled to a 3.0V biased load.

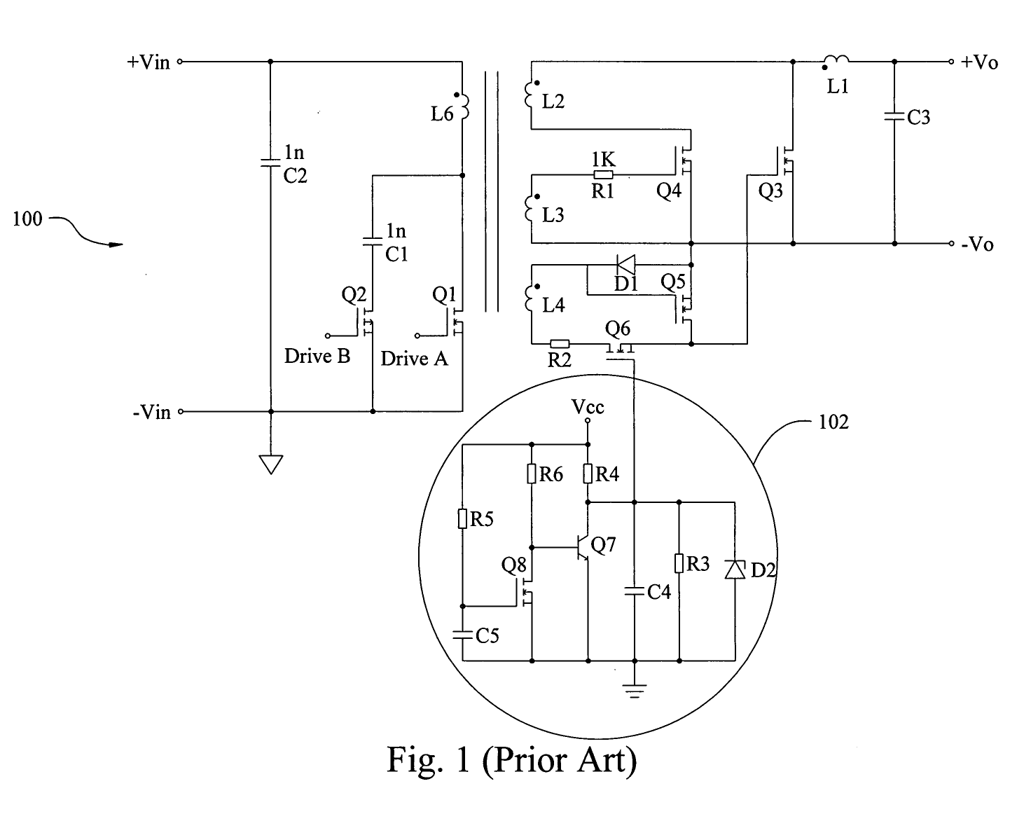

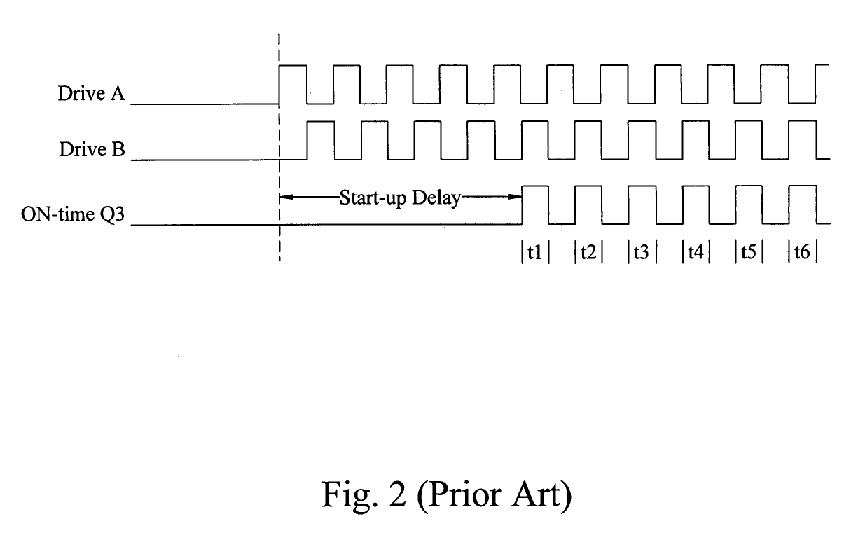

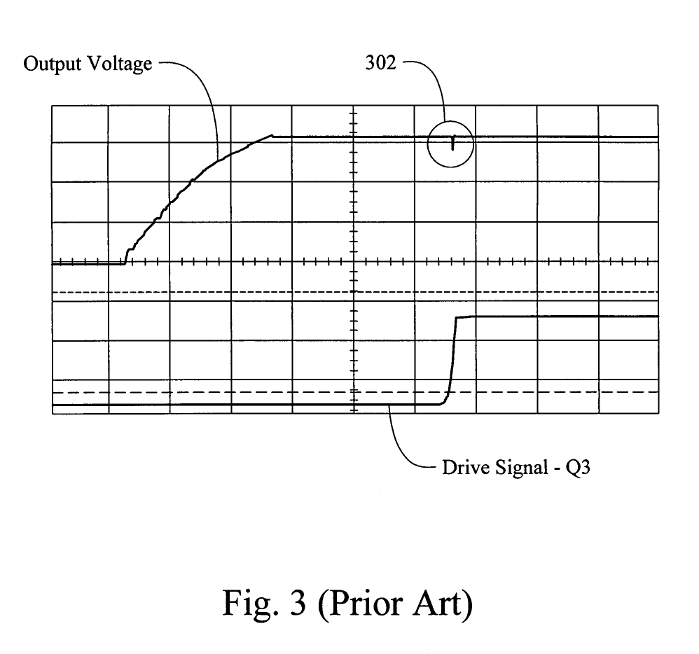

### DETAILED DESCRIPTION

The following description is merely exemplary in nature and is not intended to limit the present disclosure, application, or uses.

According to one aspect of the present disclosure, a method is provided for controlling a freewheel switch during start-up of a switch mode power supply to inhibit negative output current. The switch mode power supply has alternating first and second intervals, and the freewheel switch has an ON-time and an OFF-time. The method includes gradually increasing the ON-time of the freewheel switch over a plurality of the second intervals during start-up of the switch mode power supply until the ON-time of the freewheel switch is substantially equal to a duration of the second interval. Gradually increasing the ON-time of the freewheel switch in this manner allows the power supply to effectively transition into synchronous rectification mode without experiencing significant negative output voltage or a corresponding drop in output voltage.

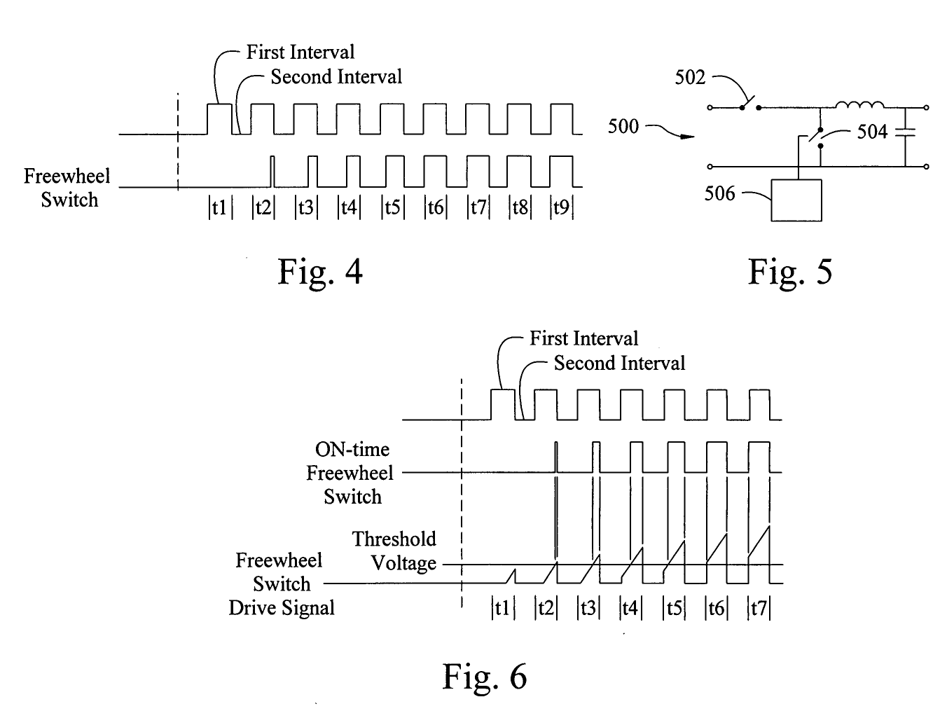

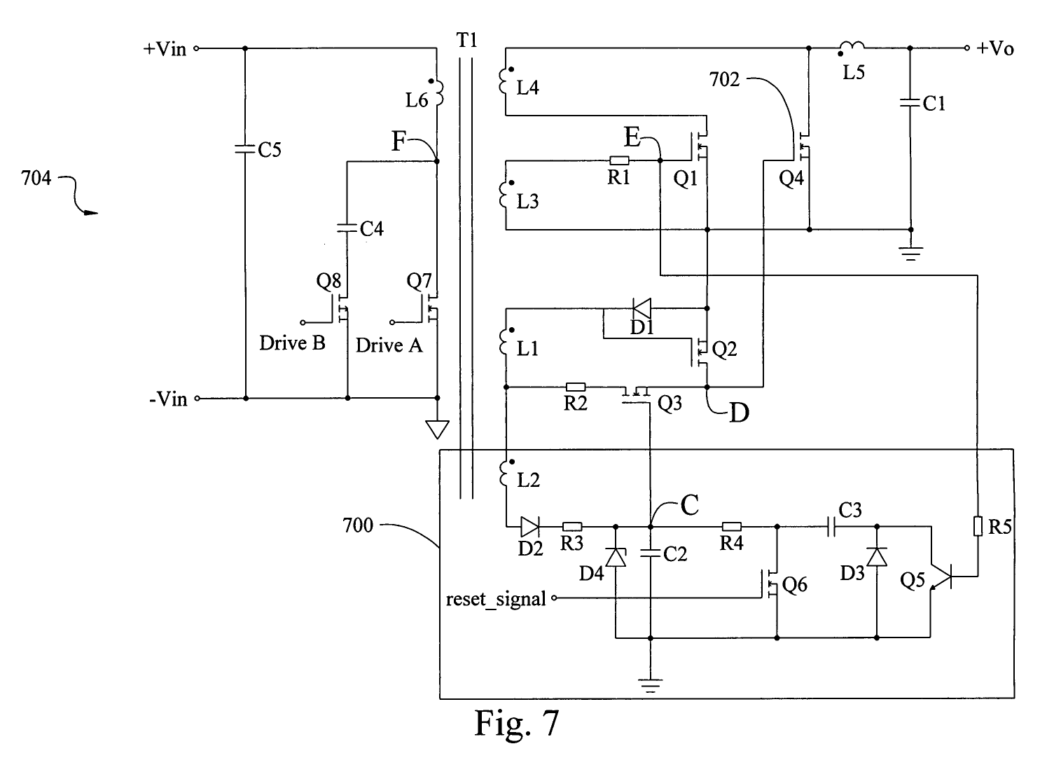

FIG. 4 illustrates one example of how the ON-time of a freewheel switch in a switch mode power supply can be increased over a plurality of intervals in accordance with the present disclosure. In particular, the ON-time is increased for each successive second interval t1-t6. In the specific example of FIG. 4, the ON-time of the freewheel switch becomes substantially equal to the duration of the second interval after six successive second intervals. It should be appreciated that the number of intervals required for the ON-time of the freewheel switch to become substantially equal to the duration of the second interval may be different in any given implementation. Preferably, the ON-time of the freewheel switch is gradually increased over each successive second interval.

Also shown in FIG. 4, an initial ON-time of the freewheel switch is delayed until interval t2. The delay can be considered a start-up delay to ensure transient perturbations settle before allowing the freewheel switch to be turned ON. While the inclusion of a start-up delay may be preferred in some embodiments, it should be appreciated that a longer, a shorter, or no start-up delay may be employed in other embodiments of the present disclosure.

According to another embodiment of the present disclosure, a switch mode power supply having alternating first and second intervals is illustrated in FIG. 5 and generally referenced 500. The switch mode power supply 500 includes a switch 502. The switch mode power supply 500 also includes a freewheel switch 504 and a control circuit 506. The control circuit 506 is coupled to the freewheel switch 504 for defining an ON-time of the freewheel switch 504. During start-up of the switch mode power supply 500, the control circuit 506 is configured to gradually increase the ON-time of the freewheel switch 504 over a plurality of second intervals. Gradually increasing the ON-time inhibits negative output current. The ON-time of the freewheel switch 504 is increased until the ON-time is substantially equally to the duration of the second interval. The switch mode power supply 500 transitions to synchronous rectification mode when the freewheel switch 504 is ON during substantially all the second interval.

Durations of the first and second intervals are generally based on a load coupled to the switch mode power supply 500. In use, the switch mode power supply 500 is generally coupled to a load. The load can be a pre-biased load or an un-biased load. When a condition of the load changes, the switch 502 adjusts one or more of the first and second intervals to meet output requirements. A change in load condition often includes a variation in a current demand from the switch mode power supply 500. Changes in first and second intervals can be made during start-up of the switch mode power supply 500 or during synchronous rectification mode.

The control circuit 506 can include a number of different circuits for gradually increasing the ON-time of the freewheel switch 504. In one example, the control circuit 506 is coupled to a drive switch for providing a drive signal to the freewheel switch 504. The control circuit 506 includes a capacitor coupled to the drive switch and a resistor coupled to the capacitor. The resistor and capacitor define a rate of charge for the capacitor, which defines the drive signal to the freewheel switch via the drive switch. FIG. 6 illustrates the gradually increase of the drive signal defined by the resistor and capacitor. The drive signal increases over a plurality of second intervals during start-up of the switch mode power supply 500.

A threshold voltage of the freewheeling switch is shown in FIG. 6. When the drive signal becomes at least equal to the threshold voltage, a portion of the drive signal at least equal to the threshold voltage defines an ON-time of the freewheel switch. As shown in FIG. 6, the portion of the drive signal at or above the threshold voltage gradually increases as the drive signal increases over successive second intervals t1-t6. The portion of the drive signal increases until the ON-time is substantially equal to the duration of the second interval, as shown at interval t6.

While the control circuit described with reference to FIG. 6 includes passive components to gradually increase the ON-time of the freewheel switch, it should be appreciated that other control circuits may be included in the switch mode power supply 500 of FIG. 5. For example, a processing device (e.g. microprocessor, microcontroller, etc.) or a logic device (e.g. programmable logic device) can be employed to gradually increase the ON-time of a freewheel switch in a switch mode power supply.

In some embodiments, multiple switch mode power supplies with current share functionality can be coupled in parallel to a single load. The number of power supplies can depend on one or more load conditions of the particular application, such as a current demand, a pre-biased, etc.

According to another embodiment of the present disclosure, a control circuit 700 for controlling a freewheel switch 702 of a switch mode power supply 704 is disclosed. The switch mode power supply 704 has alternating power and clamp intervals. The switch mode power supply 704 includes a clamp switch Q8, and a power switch Q7. When the power switch Q7 is ON, the switch mode power supply 704 is in the power interval. When the clamp switch Q8 is ON, the switch mode power supply 704 is in the clamp interval. The switch mode power supply 704 also includes a transformer T1 including a primary winding L6 and four secondary windings L1-L4. The secondary windings L1, L3, and L4 are coupled to switches Q1-2, drive switch Q3 and freewheel switch Q4.

The control circuit 700 includes transformer winding L2, which is coupled to a diode D2. The diode D2 is coupled in series with a resistor R3 and a capacitor C2. A capacitor C3 is coupled to the capacitor C2. The capacitor C3 is also coupled to a charging switch Q5 via a resistor R4.

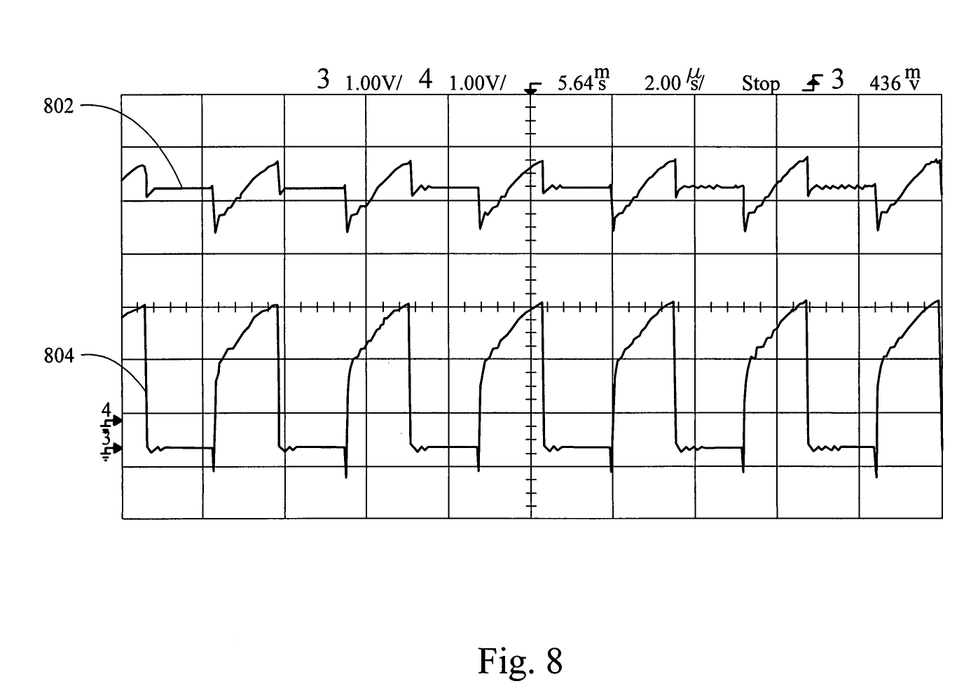

During start-up of the switch mode power supply, the control circuit 700 conforms to the following description during power and clamp intervals. During the clamp interval, a positive voltage is induced at an un-dotted terminals of secondary winding L1 and secondary winding L2, and a negative voltage is induced at a dotted terminal of L3. The voltage at an un-dotted terminal of secondary winding L2 biases the diode D2 and charges capacitor C2 via the resistor R3. The capacitor C2 and resistor R3 form an RC circuit, defining the rate of charge of the capacitor C2. The rate of charge can be seen in a waveform 802 illustrated in FIG. 8. The waveform 802 is measured at the output of the control circuit 700 (denoted Point C). The negative voltage induced at the dotted terminal of secondary winding L3 keeps the charging switch Q5 from turning ON. While the charging switch Q5 is OFF, no current flows through the capacitor C3 and the resistor R4.

During the power interval, negative voltage is induced at an un-dotted terminal of winding L2, which reverse biases the diode D2. The reverse biasing of the diode D2 prevents current flow through the resistor R3 into the capacitor C2. Positive voltage is induced at dotted terminals of secondary winding L1 and secondary winding L2. Diode D1 is reversed biased and switches Q1, Q2 are turned ON. Accordingly, the drive signal to the freewheel switch Q4 is OFF. Positive voltage is induced at the dotted terminal of L3, which turns ON charging switch Q5. When charging switch Q5 is turned ON, at least some of the charge in capacitor C2 flows into capacitor C3, through a resistor R4. The charge is shared until equal voltage is present in the capacitor C2 and the capacitor C3. In general, capacitance of the capacitor C3 is at least ten times bigger than capacitance of the capacitor C2. In the control circuit 700, the capacitor C2 is 680 pF, and the capacitor C3 is 0.1 μF. In other embodiments, a different capacitance for capacitors C2, C3 may be employed depending on the particular application.

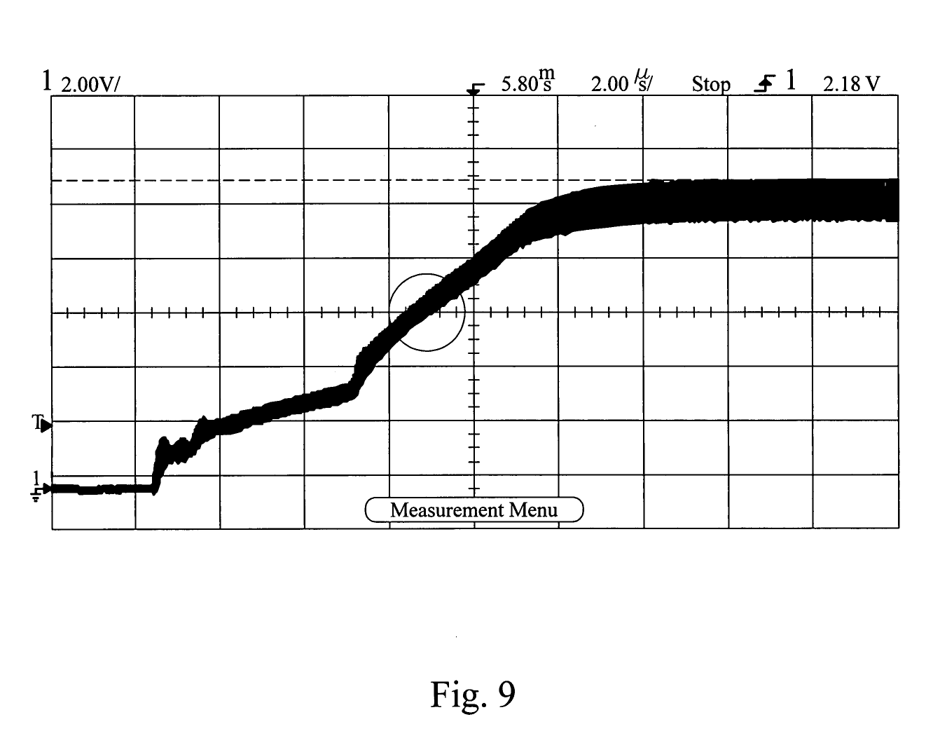

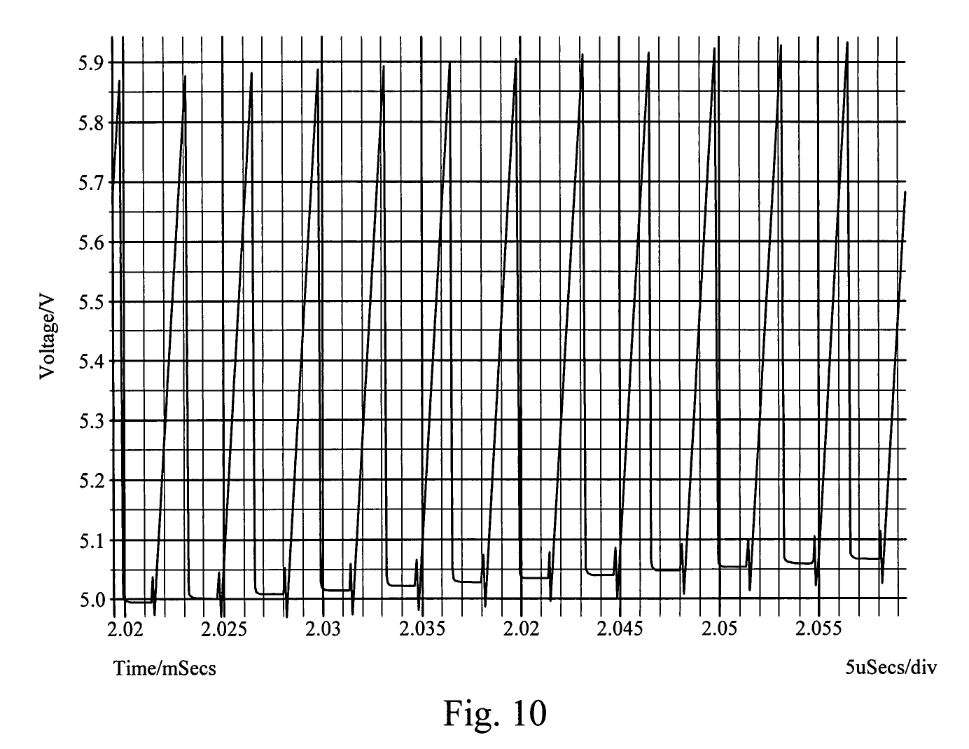

As the charge is shared between the capacitors C2, C3, capacitor C2 retains a portion of the charge. Thus, the capacitor C2 will charge from a higher voltage during subsequent clamp intervals. As the switch mode power supply 704 cycles through alternating power and clamp intervals, charge in the capacitor C2 increases. FIG. 9 illustrates the charge of the capacitor C2 during the start-up of the switch mode power supply 704. While the gradual increase in the charge of the capacitor C2 is not visible in FIGS. 8 and 9 due to scaling, a simulated waveform is shown in FIG. 10 to illustrate the gradual increase in the charge of the capacitor C2 (at point C). As shown, the charge in the capacitor C2 increases about 0.7V over twelve (12) clamp intervals. It should be appreciated that the number of power and clamp intervals during start-up may be substantially different depending on the particular application. In the control circuit 700, start-up of the switch mode power supply 704 includes more than one hundred alternating power and clamp intervals.

As the charge of the capacitor C2 increases, the charge eventually exceeds a threshold voltage of the drive switch Q3. When the drive switch Q3 is ON, the voltage at the gate of the freewheel switch Q4 is equal to the voltage in the capacitor C2 less a threshold voltage of switch Q3. (V_{G}=V_{C2}−V_{threshold}). The difference in the voltage of the capacitor C2 and the threshold voltage of the drive switch Q3 is illustrated in a waveform 804 of FIG. 8, measured at the gate of the freewheel switch Q4 (Point D).

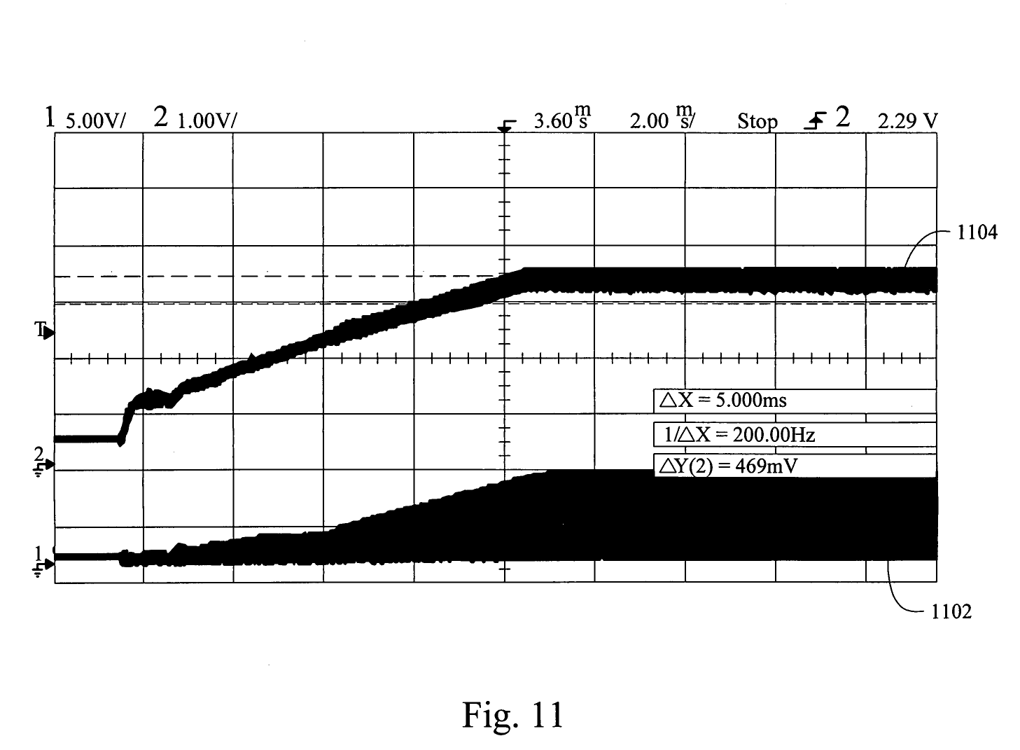

As the charge in the capacitor C2 increases as shown in FIG. 9, the drive signal to the freewheel switch Q4 gradually increases. The gradual increase of voltage at the gate of the freewheel switch Q4 (point D) is shown in a waveform 1102 of FIG. 11. As the number of power and clamp intervals is repeated, the voltage at point D approaches the threshold voltage of freewheeling switch. Once the voltage at point D (V_{G}=V_{C2}−V_{threshold}) is at least the threshold voltage of the freewheeling switch Q4, the freewheel switch Q4 turns ON for a portion of the clamp interval. After a plurality of clamp intervals, the voltage at point D increases the ON-time of the freewheel switch to be substantially equal to the duration of the clamp interval. The charge of the capacitors C2, C3 ultimately reach a voltage limit, and the switch mode power supply 704 transitions into synchronous rectification mode. While the gate voltage increase per interval is not visible in a waveform 1102 of FIG. 11, the increase in the ON-time of the freewheel switch Q4 is gradually increased to be substantially equal to the clamp interval over between about thirty (30) and about fifty (50) successive clamp intervals. In other embodiments, the plurality of said intervals can include a different number of intervals depending on the particular application.

An output voltage of the switch mode power supply 704 is illustrated in a waveform 1104 in FIG. 11. As shown, the output voltage 1104 does not exhibit a voltage drop when the freewheel switch 708 is initially turned ON.

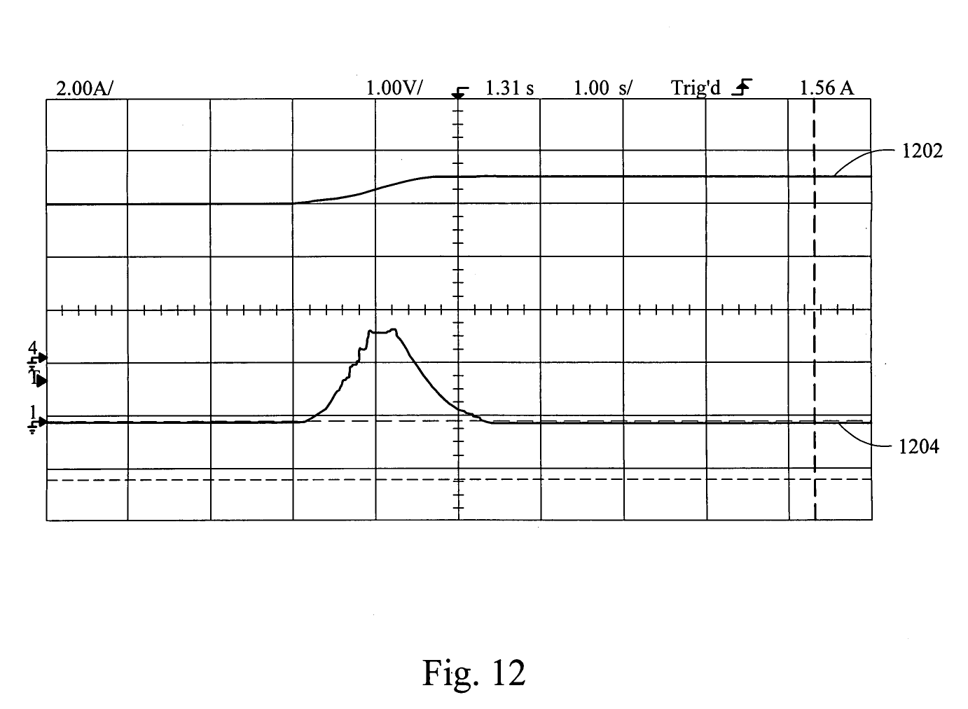

FIG. 12 illustrates a voltage output waveform 1202 and a current output waveform 1204 of the switch mode power supply 704 during start-up. During a start-up illustrated in FIG. 12, the switch mode power supply 704 was coupled to a 3.0V biased load. As shown, no negative output current flows from the external biased load to the switch mode power supply 704, and thus no voltage drop in the output voltage of the switch mode power supply occurs. Accordingly, the control circuit 700 sufficiently inhibits negative output current during the start-up of the switch mode power supply 704.

The start-up of the switch mode power supply is completed when the capacitors C2, C3 reach the voltage limit. In this particular embodiment, the voltage limit is defined by a voltage limiting device D4. The voltage limiting device is a zener diode having a breakdown voltage, which defines the limit of charging the capacitors C2, C3. The voltage limit defined by the zener diode protects the capacitors C2, C3 from excessive voltage. While the voltage limiting device in this embodiment is a zener diode, it should be appreciated that a different voltage limiting device may be employed in other embodiments of the present disclosure. For example, the secondary winding L2 can provide a voltage limit for charging the capacitors C2, C3.

While the switches Q1-4 and switches Q7-8 are illustrated as MOSFETs, it should be appreciated that a different type of switch can be employed in other embodiments of the present disclosure. For example, one or more of the switches Q1-4 and Q7-8 can be a different type of field effect transition (FET), a bipolar junction transistor, an isolated gate bipolar transistor (IGBT), etc. It should also be appreciated that the switch Q5 can be a different type of switch.

While the switch mode power supply 704 is an active clamp forward converter, it should be appreciated that a different type of switch mode power supply can be employed in other embodiments of the present disclosure. For example, a switch mode power supply can be a full bridge power supply with synchronous rectification, a half bridge power supply with synchronous rectification, or a fly-back power supply with synchronous rectification.

The control circuit 700 also includes a diode D3 and a reset switch Q6 coupled in parallel with the capacitor C2. When the reset switch receives a reset signal, the reset switch is turned ON. When the reset switch is ON, the capacitor C2 discharges via the resistor R4, and the capacitor C3 is discharged via the diode D3. The reset signal is applied to the reset switch Q6 before start-up to ensure operation of the control circuit 700 in accordance with the description above.

Although several aspects of the present invention have been described above with reference to switch mode power supplies, it should be understood that various aspects of the present disclosure are not limited to switch mode power supplies, and can be applied to a variety of other power supplies.

By implementing any or all of the teachings described above, a number of benefits and advantages can be attained including improved system reliability, reduced system down time, elimination or reduction of redundant components or systems, avoiding unnecessary or premature replacement of components or systems, and a reduction in overall system and operating costs.

What is claimed is:

1. A method of controlling a freewheel switch during start-up of a switch mode power supply to inhibit negative output current, the switch mode power supply having alternating first and second intervals, the freewheel switch having an ON-time and an OFF-time, the method comprising gradually increasing the ON-time of the freewheel switch over a plurality of said second intervals during start-up of the switch mode power supply until the ON-time of the freewheel switch is substantially equal to a duration of the second interval.

2. The method of claim 1 wherein gradually increasing includes gradually increasing the ON-time of the freewheel switch over a plurality of successive second intervals until the ON-time of the freewheel switch is substantially equal to the duration of the second interval.

3. The method of claim 2 wherein the switch mode power supply includes a first switch that is closed during each first interval and a second switch that is closed during each second interval.

4. The method of claim 3 wherein the first switch is a power switch and the second switch is clamp switch.

5. The method of claim 1 further comprising adjusting durations of the first and second intervals in response to a load condition.

6. A switch mode power supply having alternating first and second intervals, the switch mode power supply comprising a main switch, a freewheel switch, and a control circuit for defining an ON-time of the freewheel switch, the power supply configured to close the main switch during each first interval, the control circuit configured to gradually increase the ON-time of the freewheel switch over a plurality of the second intervals during start-up of the switch mode power supply until the ON-time of the freewheel switch is substantially equal to a duration of the second interval to thereby inhibit negative output current in the switch mode power supply.

7. The switch mode power supply of claim 6 wherein the control circuit is configured to gradually increase the ON-time of the freewheel switch over a plurality of successive second intervals during start-up of the switch mode power supply.

8. The switch mode power supply of claim 6 further comprising a drive switch coupled to the freewheel switch, wherein the control circuit is configured to gradually increase the ON-time of the freewheel switch via the drive switch.

9. The switch mode power supply of claim 8 wherein the control circuit includes a first capacitor coupled to the drive switch, the first capacitor configured to charge during each second interval, and wherein the ON-time of the freewheel switch during the second interval is defined by charge stored in the first capacitor.

10. The switch mode power supply of claim 9 wherein the control circuit includes a second capacitor coupled to the first capacitor, the second capacitor configured to charge from the first capacitor during the first interval.

11. The switch mode power supply of claim 10 further comprising a transformer coupled to the control circuit and configured to charge the first capacitor during the second interval.

12. A control circuit for controlling a switch mode power supply having a drive switch, a freewheel switch, a main switch, and alternating first and second intervals, the main switch configured to close during each first interval, the control circuit comprising a first capacitor for providing a drive signal to the freewheel switch via the drive switch, the drive signal defining the ON-time of the freewheel switch, and a resistor coupled to the first capacitor, the first capacitor configured to charge during the second interval, the resistor and the first capacitor configured to gradually increase the drive signal over a plurality of said second intervals during start-up of the switch mode power supply until the ON-time of the freewheel switch is substantially equal to a duration of the second interval.

13. The control circuit of claim 12 wherein the freewheel switch has a threshold voltage and wherein the drive signal turns ON the freewheel switch when the drive signal is equal to or greater than said threshold voltage.

14. The control circuit of claim 12 wherein the control circuit includes a second capacitor coupled to the first capacitor and a charging switch coupled to at least one of the first and second capacitors, the charging switch configured to transfer at least a portion of charge stored in the first capacitor to the second capacitor during the first interval.

15. The control circuit of claim 14 further comprising a voltage limiting device in parallel with at least one of the first capacitor and the second capacitor, the voltage limiting device defining a maximum voltage across at least one of the first capacitor and the second capacitor.

16. The control circuit of claim 14 wherein the second capacitor has a capacitance at least ten times greater than the first capacitor.

17. The control circuit of claim 12 further comprising a transformer winding and a diode coupled in series with the resistor and the first capacitor for forward biasing the diode during the second interval and reverse biasing the diode during the first interval.

18. The control circuit of claim 12 further comprising a reset switch coupled in parallel with the first capacitor to at least partially discharge at least one of the first capacitor and the second capacitor when a reset signal is received.

19. A switch mode power supply comprising the control circuit of claim 12.
